(19) United States
(12) Patent Application Publication
(10) Pub. No.: US 2026/0131813 A1
(43) Pub. Date: May 14, 2026

(54) DISPLAY DEVICE FOR VEHICLES

(71) Applicant: Nippon Seiki Co., Ltd., Niigata (JP)

(72) Inventors: Yuji INOSAKA, Niigata (JP); Yuri SATO, Niigata (JP)

(21) Appl. No.: 19/362,005

(22) Filed: Oct. 17, 2025

(30) Foreign Application Priority Data
Nov. 8, 2024 (JP) 2024-195553

(51) Int. Cl. B60W 50/14; B60K 35/234; B60K 35/81; B60N 2/20; B60W 60/00; G09G 3/00

(52) U.S. Cl. CPC B60W 50/14; B60K 35/234; B60K 35/81; B60W 60/0051; G09G 3/001; B60K 2360/175; B60K 2360/23; B60K 2360/31; B60N 2/20; B60W 2050/146; B60W 2540/223; G09G 2340/045; G09G 2354/00; G09G 2380/10

(57) ABSTRACT

A display device for vehicles includes a display unit that transmits light from a light source and displays a virtual or real image, a reflection unit that reflects first or second display light representing the virtual or real image, and a control unit. The control unit executes, a display switching process for performing display switching to cause the virtual image to be visible during a manual driving mode, and to cause the real image to be visible during an automatic driving mode, a seat detection process for detecting switching of the position or posture of a seat in association with switching between the manual driving mode and the automatic driving mode, and a switching notification process for providing switching notification by dynamic display of a first or second image corresponding to the virtual or real image, during the switching between the virtual image and the real image.

### DESCRIPTION

### Technical Field

The present invention relates to a display device for vehicles that displays a desired display to an occupant in a vehicle.

### Background Art

Conventionally, an in-vehicle display system disclosed in Patent Document 1 is known, for example. In this in-vehicle display system, when the vehicle is switched from a manual driving mode to an automatic driving mode, various information for an occupant (a driver) is switched from virtual image display to real image display, and when the vehicle is switched from the automatic driving mode to the manual driving mode, various information for the occupant (the driver) is switched from real image display to virtual image display.

Further, for example, a field of view control device described in Patent Document 2 is known. This field of view control device controls a seat to move upward or tilt forward when the vehicle is switched to automatic driving.

### PRIOR ART DOCUMENT

### Patent Document

Patent Document 1: Japanese Unexamined Patent Application Publication No. 2019-18804
Patent Document 2: Japanese Unexamined Patent Application Publication No. 2019-48519

### SUMMARY OF INNOVATION

### Technical Problem

In recent years, to further improve driving assistance functions for occupants, a technology for combining the display switching process between a real image and a virtual image as described in Patent Document 1 with the seat switching process of the position or posture of a seat as described in Patent Document 2 is being investigated.

However, if, when switching between driving modes is performed, the timing of completion of the switching of the position or posture of the seat does not coincide with the timing of completion of the display switching, there may be a case where the display switching will be completed some time after completion of the seat switching, or a case where the seat switching will be completed some time after completion of the display switching. In such cases, there are two timings at which an occupant can feel that the driving mode has been switched, and thus the occupant cannot be strongly impressed with the switching of driving mode.

The present invention has been made in view of the above problems, and an object thereof is to provide a display device for vehicles that can strongly impress an occupant with switching of driving mode.

### Solution to Problem

The present invention is a display device for vehicles 1, for being installed in a vehicle C including a seat 50 for an occupant DR and a light transmissive member WS and for emitting display light L11, L22 from an emission port 17 toward the light transmissive member WS to switchably cause a first display image VI or a second display image RI, which are display images represented by the display light L11, L22, to be visible. The display device for vehicles includes, a display unit 12b, 12a that includes a display component, transmits light emitted by a light source 11b, 11a, and displays the first display image VI or the second display image RI, a reflection unit 13 that reflects, toward the light transmissive member WS, first display light L22 or second display light L11 representing the first display image VI or the second display image RI displayed on the display unit 12b, 12a, respectively, and a control unit 15. The control unit 15 executes, a display switching process for performing display switching to cause the first display image VI to be visible when the vehicle C is in a manual driving mode, and to cause the second display image RI to be visible when the vehicle C is in an automatic driving mode, a seat detection process for detecting switching of the position or posture of the seat 50 in association with switching between the manual driving mode and the automatic driving mode of the vehicle C, and a switching notification process for providing switching notification by dynamic display of a first image or a second image corresponding to the first display image VI and the second display image RI, respectively, during the switching between the first display image VI and the second display image RI in the display switching process.

### Advantageous Effects of Invention

According to the present invention, an occupant can be strongly impressed with switching of driving mode.

### BRIEF DESCRIPTION OF DRAWINGS

FIG. 1 is a diagram illustrating configuration of a head-up display device according to an embodiment of the present invention.

FIG. 2 is a functional block diagram illustrating functional configuration of a control unit in the head-up display device.

FIG. 3 is an explanatory diagram illustrating behavior of dynamic display when switching from a manual driving mode to an automatic driving mode is performed.

FIG. 4 is an explanatory diagram illustrating behavior of dynamic display when switching from the automatic driving mode to the manual driving mode is performed.

FIG. 5A is a diagram illustrating a time chart of switching from the manual driving mode to the automatic driving mode, and FIG. 5B is a diagram illustrating a time chart of switching from the automatic driving mode to the manual driving mode.

FIG. 6 is an explanatory diagram illustrating behavior of dynamic display when switching from the manual driving mode to the automatic driving mode is performed, according to a variation in which fade-in and fade-out are performed in accordance with sliding of the seat portion.

FIG. 7 is an explanatory diagram illustrating behavior of dynamic display when switching from the automatic driving mode to the manual driving mode is performed, according to the variation in which fade-in and fade-out are performed in accordance with sliding of the seat portion.

FIGS. 8A and 8B are explanatory diagrams illustrating relationship between the region of an eyebox and display of the virtual image and the real image, according to a variation in which the posture of a concave mirror is changed in conjunction with dynamic display of switching notification.

### DESCRIPTION OF EMBODIMENTS

An embodiment of the present invention will be described with reference to the drawings.

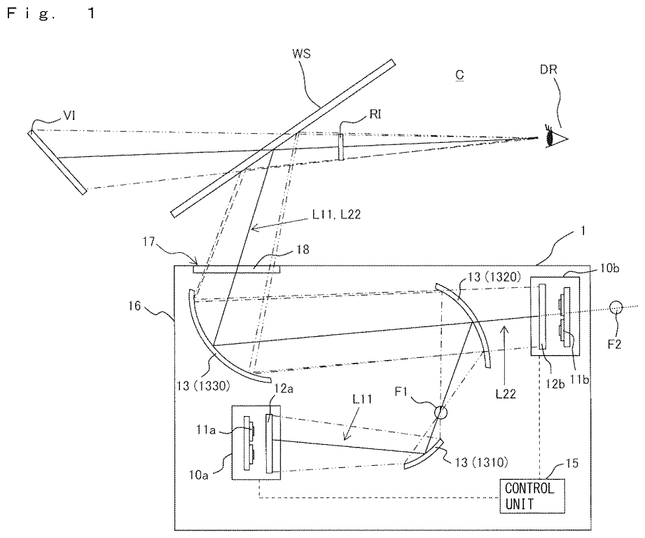

FIG. 1 is a diagram illustrating configuration of a head-up display device (hereinafter referred to as an HUD device) which is a display device for vehicles according to the present embodiment. An HUD device 1 in FIG. 1 includes a first PGU 10b including a first light source 11b that emits light in the visible wavelength range, for example, and a first display unit 12b that transmits the light emitted by the first light source 11b and displays a virtual image VI (a first display image) of a display image that is formed in front of a driver DR (an occupant), a second PGU 10a including a second light source 11a that emits light in the visible wavelength range, for example, and a second display unit 12a that transmits the light emitted by the second light source 11a and displays a real image RI (a second display image) of the display image that is formed in front of the driver DR, a reflection unit 13 that reflects, toward a windshield WS (a light transmissive member), first display light L22 representing the display image (the first display image) displayed on the first display unit 12b and second display light L11 representing the display image (the second display image) displayed on the second display unit 12a, and a control unit 15 that performs control of display content of the first display unit 12b and the second display unit 12a, and switching control between the first PGU 10b and the second PGU 10a, and the like. The first PGU 10b, the second PGU 10a, the reflecting unit 13, and the control unit 15 are housed in a housing 16. The housing 16 is provided with an opening portion 17 (an emission port) through which the second display light L11 and the first display light L22 are emitted, and a cover glass 18 for protecting the inside is disposed at the opening portion 17. The first display unit 12b and the second display unit 12a are examples of a display unit.

Note that the first PGU 10b and the second PGU 10a may be controlled by a single control unit 15, as illustrated in FIG. 1, or the first PGU 10b and the second PGU 10a may each include an individual control unit and these individual control units may be cooperatively controlled by the control unit 15.

### Display Light

The HUD device 1 is disposed below the windshield WS of a vehicle C (for example, inside an instrument panel), and emits and projects the first display light L22 and the second display light L11 onto the windshield WS. The first display light L22 is generated by the first light source 11b and the first display unit 12b inside the HUD device 1, and the second display light L11 is generated by the second light source 11a and the second display unit 12a inside the HUD device 1.

The first display light L22 emitted from the first display unit 12b and the second display light L11 emitted from the second display unit 12a are guided by the reflection unit 13 and emitted from the opening portion 17 of the housing 16 through the cover glass 18. When the driver DR of the vehicle C visually recognizes the second display light L11 reflected by the windshield WS, the driver DR can visually recognize the real image RI on the near side relative to the windshield WS (a real image display state). When the driver DR visually recognizes the first display light L22 reflected by the windshield WS, the driver DR can visually recognize the virtual image VI on the far side relative to the windshield WS (a virtual image display state).

### Virtual Image and Real Image

The virtual image VI in FIG. 1 displays information to be provided to the driver DR at a high priority, such as vehicle information including the speed and engine speed of the vehicle C, a route guidance display including turn-by-turn navigation and a map, and a warning display including a blind spot indicator and a speed limit exceeding warning, on the far side relative to the windshield WS as seen from the driver DR.

The real image RI in FIG. 1 displays, for example, entertainment content, an assistant or agent that supports the driver DR, or a character representing them, on the near side relative to the windshield WS as seen from the driver DR. These displays provide a driving environment with reduced need for eye movement and eye focal length adjustment. The virtual image VI and real image RI include a background portion in addition to characters and icons representing such information, and the background portion has, for example, a substantially rectangular shape in a plan view when viewed from the driver DR.

### PGU

In the second PGU 10a, the second light source 11a is, for example, a light-emitting diode that emits light in the visible wavelength range and is mounted on a wiring board, and emits white light. The second display unit 12a is provided closer to the opening portion 17 along the optical path than the second light source 11a, and includes a TFT-type second display component (not illustrated in FIG. 1) that forms the second display light L11 representing any image in accordance with a control signal sent from the control unit 15.

In the first PGU 10b, the first light source 11b is, for example, a light-emitting diode that emits light in the visible wavelength range and is mounted on a wiring board, and emits white light. The first display unit 12b is provided closer to the opening portion 17 along the optical path than the first light source 11b, and includes a TFT-type first display component (not illustrated in FIG. 1) that forms the first display light L22 representing any image in accordance with a control signal sent from the control unit 15.

In addition to the above, in the first PGU 10b and the second PGU 10a, optical components such as a condenser lens, a lenticular lens, a diffuser, and a polarizer may be disposed at any position downstream of the first light source 11b and the second light source 11a.

### Reflection Unit

In FIG. 1, the reflection unit 13 includes a second correction mirror 1310 that reflects the second display light L11 emitted from the second display unit 12a toward a first correction mirror 1320, the first correction mirror 1320 that reflects the second display light L11 emitted from the second correction mirror 1310 toward a concave mirror 1330, and the concave mirror 1330 that receives the second display light L11 reflected and redirected by the second correction mirror 1310 and the first correction mirror 1320 and the first display light L22 that has passed through the first correction mirror 1320 and reflects them toward the opening portion 17.

### Correction Mirrors and Concave Mirror

The first correction mirror 1320 and the second correction mirror 1310 have mirror surfaces and have complex free-form shapes to correct distortion of the image to be visually recognized by the driver DR. The first correction mirror 1320 is, for example, a half mirror, and transmits the first display light L22 which represents the virtual image VI displayed on the first display unit 12b. The first display light L22 that has passed through the first correction mirror 1320 is directly incident on the concave mirror 1330.

The concave mirror 1330 is rotatably installed and rotates in accordance with the position of the eyes of the driver DR to freely change the emission directions of the second display light L11 and the first display light L22 to adjust the position of the image. In particular, the angle of the display plane when the real image RI is displayed by the second display light L11 may desirably be different from that when the virtual image VI is displayed by the first display light L22 (for example, the virtual image VI is displayed in a state of being inclined relative to the road surface, while the real image RI is displayed in a state of standing perpendicularly to the road surface). Such adjustment by rotational drive makes it possible to display the display images at angles appropriate for the real image RI and virtual image VI, respectively.

The second correction mirror 1310 is disposed along the optical path of the second display light L11 closer to the opening portion 17 than the second PGU 10a, and is disposed closer to the second PGU 10a than a second optical focus F1 of the imaging optical system including the windshield WS, the first correction mirror 1320, and the concave mirror 1330.

The first display unit 12b of the first PGU 10b is disposed along the optical path of the first display light L22 closer to the opening portion 17 than the position of a first optical focus F2 of the imaging optical system including the windshield WS and the concave mirror 1330.

In the optical system formed by the first correction mirror 1320, the concave mirror 1330, and the windshield WS, the first display unit 12b is located outside the focal length of that optical system.

In the optical system formed by the first correction mirror 1320, the second correction mirror 1310, the concave mirror 1330, and the windshield WS, the second display unit 12a is located inside the focal length of that optical system (in the present disclosure, between the second correction mirror 1310 and the first correction mirror 1320).

In this configuration, when the second light source 11a is turned on, i.e., when the second PGU 10a is ON, the second display light L11 emitted from the second PGU 10a is reflected by the second correction mirror 1310, the first correction mirror 1320, the concave mirror 1330, and the windshield WS, and thus the driver DR can visually recognize the real image RI on the inside of the vehicle relative to the windshield WS.

Furthermore, when the first light source 11b is turned on, i.e., when the first PGU 10b is ON, the first display light L22 emitted from the first PGU 10b passes through the first correction mirror 1320 and is reflected by the concave mirror 1330 and the windshield WS, and thus the driver DR can visually recognize the virtual image VI on the outside of the vehicle relative to the windshield WS.

In reality, countless rays of light are emitted from the first display unit 12b and the second display unit 12a, but for ease of explanation, the light emitted from the center of each of the first display unit 12b and the second display unit 12a and passing through the center of an eyebox will be referred to as representative rays and will be denoted by the reference symbols L11 and L22.

In addition, in FIG. 1, representative rays emitted from the centers of the first display unit 12b and the second display unit 12a are illustrated by solid lines, rays emitted from the upper end portions of the first display unit 12b and the second display unit 12a are illustrated by dash-dot lines, and rays emitted from the lower end portions of the first display unit 12b and the second display unit 12a are illustrated by dash-dot-dot lines.

### Control Unit

The control unit 15 includes a computer including a CPU that executes various pre-stored programs by utilizing the temporary storage function of the memory, a memory including a storage device including a RAM and a ROM, and the like. The control unit 15 cooperatively controls at least the first PGU 10b and the second PGU 10a, and performs control for switching between the real image RI and the virtual image VI by turning on/off the first light source 11b and turning on/off the second light source 11a, control of the display contents of the first display unit 12b, control of the display contents of the second display unit 12a, etc.

### Functional Configuration of Control Unit

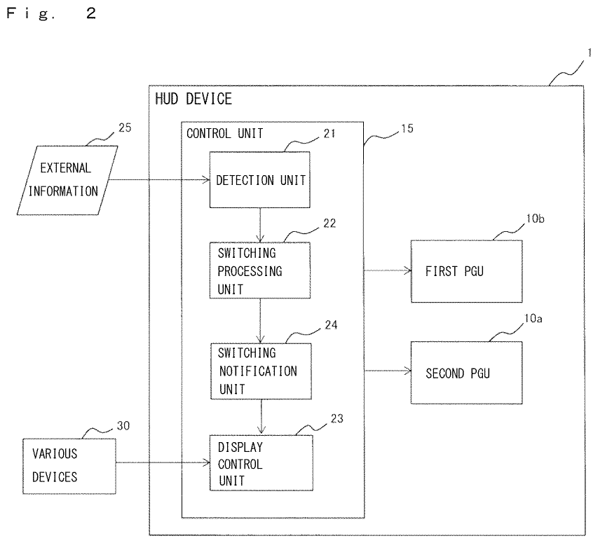

FIG. 2 is a functional block diagram illustrating functional configuration of the control unit 15 in the HUD device 1 according to the present embodiment. The control unit 15 includes a detection unit 21, a switching processing unit 22, and a display control unit 23.

The detection unit 21 acquires, as external information 25, information regarding the position or posture of a seat 50 (for example, the reclining angle of a backrest portion 52 described below and the sliding position of a seat portion 51 in the front-rear direction, etc.) that is switched in accordance with switching between the manual driving mode and the automatic driving mode of the vehicle C, for example, and detects the timing of switching between the automatic driving mode and the manual driving mode. This process executed by the detection unit 21 is an example of a seat detection process.

Based on detection result of the detection unit 21 or based on detection information of the detection unit 21, the switching processing unit 22 performs switching from the display state of the virtual image VI to the display state of the real image RI (i.e., turns off the first PGU 10b and turns on the second PGU 10a), or switching from the display state of the real image RI to the display state of the virtual image VI (i.e., turns off the second PGU 10a and turns on the first PGU 10b).

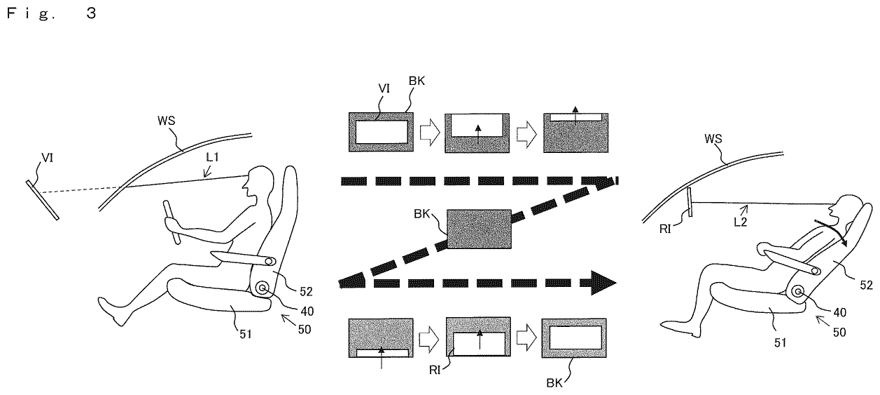

Specifically, if the vehicle C is in the manual driving mode and accordingly, the seat 50 is in a driving position (a seat state during normal driving. See, FIGS. 3 to 7, and the like described later), the switching processing unit 22 causes the virtual image VI to be displayed, and if the vehicle C is in the automatic driving mode and accordingly, the seat 50 is in a relaxed position (a state in which the seat portion 51 is reclined or is at a rearward position compared to the driving position.

See, FIGS. 3 to 7, and the like described later), the switching processing unit 22 causes the real image RI to be displayed. This process executed by the switching processing unit 22 is an example of a display switching process.

The display control unit 23 controls, based on information input from various devices 30 including a memory and the like, the display contents of the first display unit 12b and the second display unit 12a.

Specifically, the display control unit 23 outputs control signals to the first display unit 12b and the second display unit 12a to generate light representing a figure of any shape based on information sent from the various devices 30 such as a vehicle speed sensor, a navigation device, a Radio Detecting and Ranging (RADAR) device, and a Light Detection and Ranging (LiDAR, also called Laser Imaging Detection and Ranging) device, and/or content information pre-registered in a memory, etc. As a result, the first PGU 10b and the second PGU 10a display the desired display images, respectively.

### Background of Embodiment

As described above, in the present embodiment, to improve the driving assistance function for the driver DR, the switching processing unit 22 performs switching between displaying the real image RI and displaying the virtual image VI in accordance with switching of the position or posture of the seat 50 of the vehicle C in association with switching of the driving mode of the vehicle C (switching between the manual driving mode and the automatic driving mode).

However, if, when switching between driving modes is performed, the timing of completion of the switching of the position or posture of the seat 50 does not coincide with the timing of completion of the display switching, there may be a case where the display switching will be completed some time after completion of switching of the seat 50, or a case where switching of the seat 50 will be completed some time after completion of the display switching. In such cases, there are two timings at which the driver DR can feel that the driving mode has been switched. Therefore, the above configuration may not strongly impress the driver DR with switching of driving mode.

One of characteristics of the present embodiment is that, to solve the above problem, a predetermined switching notification is displayed under the control of the switching notification unit 24 of the control unit 15, during switching between the virtual image VI and the real image RI by the switching processing unit 22. Specifically, the switching notification unit 24 controls the display contents of the first display unit 12b and the second display unit 12a, such that dynamic display of a first image or a second image corresponding to the virtual image VI and the real image RI, respectively (details thereof will be described later) is performed as the switching notification, by outputting, to the display control unit 23, a signal for performing dynamic display of the first image or the second image. This process executed by the switching notification unit 24 is an example of a display notification process.

### Switching from Manual Driving Mode to Automatic Driving Mode>

FIG. 3 is an explanatory diagram illustrating behavior of the above-mentioned dynamic display when switching from the manual driving mode to the automatic driving mode is performed. As described above, the vehicle C has the manual driving mode in which the driver DR performs driving operations, and the automatic driving mode in which the vehicle C is automatically driven by a computer. In response to detection of a predetermined trigger (for example, operation on an automatic/manual selector switch by the driver DR, entering a highway or general road, or timing of parking, stopping, or driving, etc.), switching between the manual driving mode and the automatic driving mode is executed.

The seat 50 provided in the vehicle C includes the seat portion 51 on which the driver DR sits, and the backrest portion 52.

In the manual driving mode, a known drive control device (not illustrated) installed in the vehicle C reduces the tilt angle of the backrest portion 52 of the seat 50 on which the driver DR sits (the backrest portion 52 is in an upright state), as illustrated on the left side of FIG. 3. This tilt angle refers to the rearward rotation angle relative to the state in which the angle between the seat surface of the seat 50, which is arranged horizontally (in parallel to the front-rear direction), and the backrest portion 52 is an approximately right angle.

Alternatively, the height of the seat surface of the seat portion 51 may be increased. These states of the seat 50 are the so-called driving positions. In contrast, in the automatic driving mode, the tilt angle of the backrest portion 52 is increased (state in which the backrest portion 52 is reclined), as illustrated on the right side of FIG. 3. Alternatively, the height of the seat surface of the seat portion 51 may be lowered. These states of the seat 50 are the so-called relaxed position (reclining position).

In this example, a measurement sensor 40 provided at a lower part of the backrest portion 52 measures the tilt angle and outputs the tilt angle to the control unit 15. The detection unit 21 acquires the measurement result of the measurement sensor 40 as the external information 25 to detect switching between the manual driving mode and the automatic driving mode in the vehicle C. In this case, the detection unit 21 detects an angle change process executed in the vehicle C for changing the tilt angle of the backrest portion 52.

When an appropriate sensor is used to detect the height of the seat surface of the seat portion 51, instead of the measurement sensor 40, the detection unit 21 acquires the measurement result of the sensor as the external information 25 to detect switching between the manual driving mode and the automatic driving mode in the vehicle C. In this case, the detection unit 21 detects an upward-downward change process executed in the vehicle C that changes the position of the seat portion 51 in the up-down direction.

As described above, in the manual driving mode, the seat 50 is in the driving position as illustrated on the left side of FIG. 3, and the switching processing unit 22 causes the virtual image VI to be displayed. In the automatic driving mode, the seat 50 is in the relaxed position as illustrated on the right side of FIG. 3, and the switching processing unit 22 causes the real image RI to be displayed.

When the driving mode is switched from the manual driving mode to the automatic driving mode, increase in the tilt angle of the seat 50 (from the driving position to the relaxed position) is detected by the detection unit 21. In response to the detection, as illustrated above the thick dashed arrow in the figure, the switching notification unit 24 performs control for upward sliding, as a dynamic display, of the first image corresponding to the virtual image VI that had been displayed until then (in this example, the first image is the virtual image VI itself, but may also be another appropriate image corresponding to the virtual image VI), out of a background image BK located within the field of view of the driver DR, and as a result, the first image exits from the background image BK. This is followed by a state where only the background image BK is displayed, as illustrated in the middle section of the thick dashed line (in other words, a no image state where neither the virtual image VI nor the real image RI is displayed). Then, as illustrated below the thick dashed arrow in the figure, the second image corresponding to the real image RI (in this example, the second image is the real image RI itself, but may also be another appropriate image corresponding to the real image RI) slides from below into the background image BK located within the field of view of the driver DR, as a dynamic display. Finally, after achieving a state where the center of the second image substantially coincides with the center of the background image BK, switching to a display state of the real image RI corresponding to the automatic driving mode by the switching processing unit 22 is performed.

### Switching from Automatic Driving Mode to Manual Driving Mode

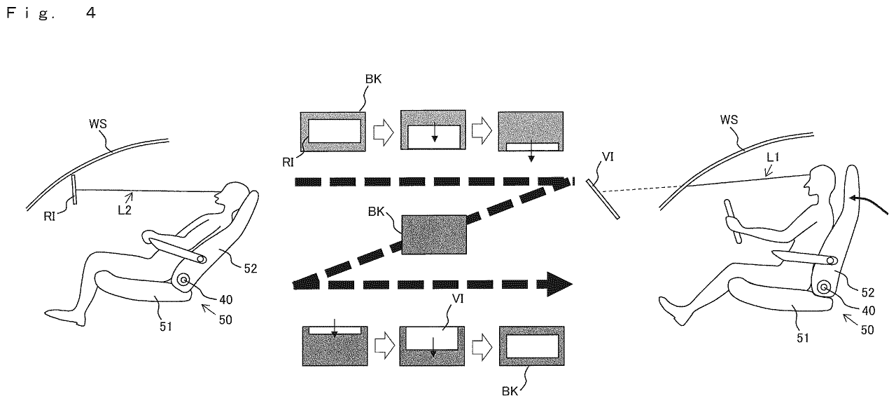

FIG. 4 is an explanatory diagram illustrating behavior of the above-mentioned dynamic display when switching from the automatic driving mode to the manual driving mode is performed.

As described above, in the automatic driving mode, the seat 50 is in the relaxed position as illustrated on the left side of FIG. 4, and the switching processing unit 22 causes the real image RI to be displayed.

In the manual driving mode, the seat 50 is in the driving position as illustrated on the right side of FIG. 4, and the switching processing unit 22 causes the virtual image VI to be displayed.

When the driving mode is switched from the automatic driving mode to the manual driving mode, decrease in the tilt angle of the seat 50 (from the relaxed position to the driving position) is detected by the detection unit 21. In response to the detection, as illustrated above the thick dashed arrow in the figure, the switching notification unit 24 performs control for downward sliding, as a dynamic display, of the second image corresponding to the real image RI that had been displayed until then (in this example, the second image is the real image RI itself, but may also be another appropriate image corresponding to the real image RI), out of the background image BK located within the field of view of the driver DR, and as a result, the second image exits from the background image BK. This is followed by a state where only the background image BK is displayed, as illustrated in the middle section of the thick dashed line (in other words, a no image state where neither the real image RI nor the virtual image VI is displayed). Then, as illustrated below the thick dashed arrow in the figure, the first image corresponding to the virtual image VI (in this example, the first image is the virtual image VI itself, but may also be another appropriate image corresponding to the virtual image VI) slides from above into the background image BK located within the field of view of the driver DR, as a dynamic display.

Finally, after achieving a state where the center of the first image substantially coincides with the center of the background image BK, switching to a display state of the virtual image VI corresponding to the manual driving mode by the switching processing unit 22 is performed.

### Dynamic Display of Switching Notification and Timing of Seat Movement

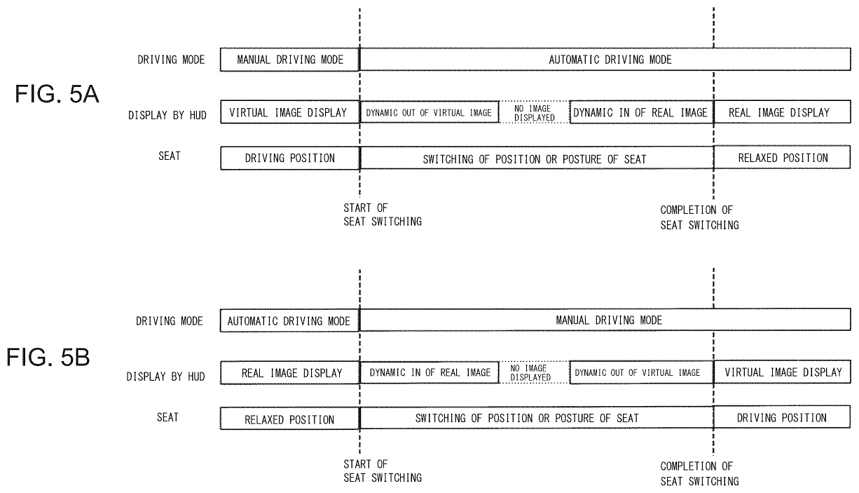

Another one of characteristics of the present embodiment is that during the display switching between the virtual image VI and the real image RI, the timing of execution of the dynamic display of the switching notification under the control of the switching notification unit 24 is caused to coincide with the timing of switching of the position or posture of the seat 50. This will be explained with reference to FIGS. 5A and 5B.

FIG. 5A is a diagram illustrating a time chart of switching from the manual driving mode to the automatic driving mode, as described above with reference to FIG. 3.

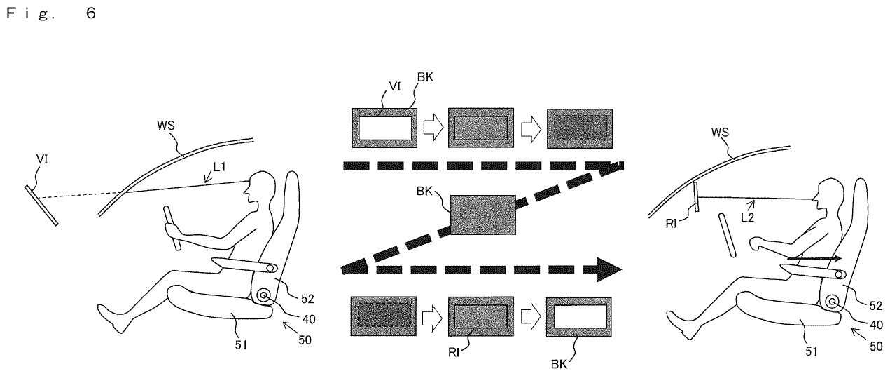

As described above, in the manual driving mode, the seat 50 is in the driving position, and the switching processing unit 22 of the HUD device 1 displays the virtual image VI. In the present embodiment, at the timing of switching from the manual driving mode to the automatic driving mode, switching of the seat 50 from the driving position to the relaxed position is started, and the above-described dynamic display (slide-out in the above-mentioned example, or fade-out in a variation illustrated in FIG. 6, which will be described later) of the first image corresponding to the virtual image VI (the virtual image VI itself in the above-mentioned example) is started. That is, the timing of the start of the dynamic display coincides with the timing of the start of the switching of the seat 50.

In the present embodiment, when the switching of the seat 50 started as described above is completed and the seat 50 is in the relaxed position, the above-described dynamic display (slide-in in the above-mentioned example, or fade-in in the variation illustrated in FIG. 6, which will be described later) of the second image corresponding to the above-described real image RI (the real image RI itself in the above example), which has already been started subsequent to the above-described dynamic display of the first image (and the intermediate state in which no image is displayed), is completed. That is, the timing of the completion of the dynamic display coincides with the timing of the completion of the switching of the seat 50.

FIG. 5B is a diagram illustrating a time chart of switching from the automatic driving mode to the manual driving mode, as described above with reference to FIG. 4.

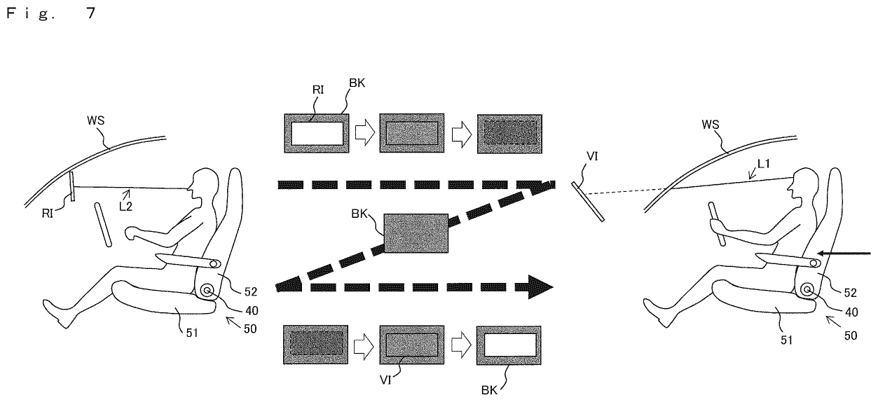

As described above, in the automatic driving mode, the seat 50 is in the relaxed position, and the switching processing unit 22 of the HUD device 1 displays the real image RI. In the present embodiment, at the timing of switching from the automatic driving mode to the manual driving mode, switching of the seat 50 from the relaxed position to the driving position is started, and the above-described dynamic display (slide-out in the above-mentioned example, or fade-out in a variation illustrated in FIG. 7, which will be described later) of the second image corresponding to the real image RI (the real image RI itself in the above-mentioned example) is started. That is, the timing of the start of the dynamic display coincides with the timing of the start of the switching of the seat 50.

In the present embodiment, when the switching of the seat 50 started as described above is completed and the seat 50 is in the driving position, the above-described dynamic display (slide-in in the above-mentioned example, or fade-in in the variation illustrated in FIG. 7, which will be described later) of the first image corresponding to the above-described virtual image VI (the virtual image VI itself in the above example), which has already been started subsequent to the above-described dynamic display of the second image (and the intermediate state in which no image is displayed), is completed. That is, the timing of the completion of the dynamic display coincides with the timing of the completion of the switching of the seat 50.

Note that, in either case of FIGS. 5A and 5B, as long as the timing of the completion of the dynamic display coincides with the timing of the completion of the switching of the seat 50, the timing of the start of the dynamic display may not necessarily coincide with the timing of the start of the switching of the seat 50.

### Effects of Embodiment

In the present embodiment configured as described above, the vehicle C has two driving modes: the manual driving mode and the automatic driving mode. The control unit 15 executes the display switching process when selective switching between the two driving modes is performed. In the display switching process, display switching is performed to cause the virtual image VI to be visible to the driver DR during the manual driving mode, and to cause the real image RI to be visible to the driver DR during the automatic driving mode. The control unit 15 detects, in the seat detection process, switching of the seat 50 executed in the vehicle C in association with switching between the above two driving modes. In the seat detection process, switching of the position or posture of the seat 50 corresponding to the switching of the driving mode is detected.

The control unit 15 of the HUD device 1 of the present embodiment executes the switching notification process during switching between the virtual image VI and the real image RI in the display switching process, in association with switching between the two driving modes. In the switching notification process, a predetermined switching notification is performed using dynamic display of the first image corresponding to the virtual image VI or the second image corresponding to the real image RI. As a result, switching notification is provided by dynamic display of the first image or the second image both during display switching from the virtual image VI to the real image RI and during display switching from the real image RI to the virtual image VI, and thus the driver DR can be strongly impressed with the switching of the driving mode.

In particular, in the present embodiment, the timing of completion of switching of the position or posture of the seat 50 detected in the seat detection process and the timing of completion of the switching notification by the dynamic display of the first image or the second image in the switching notification process, in association with the switching between the two driving modes mentioned above, coincide with each other. This provides an indication that the completion of the dynamic display is the same as the completion of the switching of the seat 50, and thus the driver DR can be surely and strongly impressed with the switching of the driving mode.

In particular, in the present embodiment, the timing of start of switching of the position or posture of the seat 50 detected in the seat detection process and the timing of start of the switching notification by the dynamic display of the first image or the second image in the switching notification process, in association with the switching between the two driving modes mentioned above, coincide with each other. This provides an indication that the start of the dynamic display is the same as the start of the switching of the seat 50, and thus the driver DR can be more surely and strongly impressed with the switching of the driving mode.

In particular, in the present embodiment, a change in the tilt angle of the backrest portion 52, the position of the seat portion 51 in the up-down direction, or the like is detected in the seat detection process, and slide-in and slide-out of the first image or the second image is performed in the switching notification process, and thus the present embodiment can provide a specific configuration for executing these two processes in conjunction with each other.

Instead of slide-in and slide-out of the first image or the second image, fade-in and fade-out of the first image or the second image may be performed as in a variation (1) described below.

In particular, in the present embodiment, in the seat detection process, a reclining motion to the back side or the opposite motion to the upright state is detected based on a change in the tilt angle of the backrest portion 52 of the seat 50, and slide-in and slide-out of the first image or the second image is performed in the switching notification process, and thus these two processes can be performed in conjunction with each other.

In particular, in the present embodiment, when the display is switched from the virtual image VI to the real image RI, the tilt angle of the seat 50 is increased, the backrest portion 52 is tilted, the driver DR's head is moved downward, and the field of view is moved upward. In accordance with this, the first image corresponding to the virtual image VI slides upward relative to the field of view of the driver DR and disappears (=slide-out), and the second image corresponding to the real image RI emerges by sliding from below into the field of view of the driver DR (=slide-in).

Similarly, when the display is switched from the real image RI to the virtual image VI, the tilt angle of the seat 50 is decreased, the backrest portion 52 is moved to the upright state, the driver DR's head is moved upward, and the field of view is moved downward. In accordance with this, the second image corresponding to the real image RI slides downward relative to the field of view of the driver DR and disappears (=slide-out), and the first image corresponding to the virtual image VI emerges by sliding from above into the field of view of the driver DR (=slide-in).

According to the present embodiment, as described above, switching notification is provided in a manner that matches the change in the height position of the driver DR's field of view due to change in the posture of the seat 50, and thus the driver DR can be more effectively impressed with the switching of driving mode.

The present invention is not limited to the above-described embodiment, and various modifications can be made within the scope of the spirit and technical concept of the present invention. Such variations will be explained below in order.

(1) Fade-In and Fade-Out in Accordance with Sliding of Seat Portion

In the above embodiment, the angle of the backrest portion 52 of the seat 50 is changed when the driving mode is switched, and slide-in and slide-out of the virtual image VI and real image RI are performed accordingly in the switching notification process, but the present invention is not limited thereto. In this variation, the position of the seat portion 51 of the seat 50 in the front-rear direction is changed (slid) when the driving mode is switched. In accordance with this, fade-in and fade-out of the virtual image VI and the real image RI are performed in the switching notification process.

### Switching from Manual Driving Mode to Automatic Driving Mode

FIG. 6 is an explanatory diagram corresponding to FIG. 3 of the above embodiment, and illustrates behavior of the dynamic display in this variation when switching from the manual driving mode to the automatic driving mode is performed.

In this variation, in the manual driving mode, a known drive control device (not illustrated) installed in the vehicle C moves the seat portion 51 of the seat 50 on which the driver DR sits, to a front side position in the front-rear direction, as illustrated on the left side of FIG. 6 (a position of the seat 50 slid forward from the position illustrated on the right side of FIG. 6). In this variation, this state of the seat 50 is the driving position. In contrast, in the automatic driving mode, the seat portion 51 of the seat 50 is at a rear side position in the front-rear direction, as illustrated on the right side of FIG. 6. This state is the so-called relaxed position (reclining position).

In this example, an appropriate sensor (not illustrated) measures the slide position in the front-rear direction and outputs the result to the control unit 15. The detection unit 21 acquires the measurement result as the external information 25 to detect switching between the manual driving mode and the automatic driving mode in the vehicle C. In this case, the detection unit 21 detects a forward-rearward change process executed in the vehicle C that changes the position of the seat portion 51 in the front-rear direction.

Note that, in this variation, similarly to the above, the switching between the manual driving mode and the automatic driving mode may be detected by detecting the height of the seat surface of the seat portion 51 with an appropriate sensor.

In FIG. 6, in the manual driving mode, the seat 50 is in the driving position as illustrated on the left side of FIG. 6, and the switching processing unit 22 causes the virtual image VI to be displayed. In the automatic driving mode, the seat 50 is in the relaxed position as illustrated on the right side of FIG. 6, and the switching processing unit 22 causes the real image RI to be displayed.

When the driving mode is switched from the manual driving mode to the automatic driving mode, rearward motion (in the front-rear direction) of the seat 50 (from the driving position to the relaxed position) is detected by the detection unit 21. In response to the detection, as illustrated above the thick dashed arrow in the figure, the switching notification unit 24 performs control, as a dynamic display, such that brightness of the first image corresponding to the virtual image VI that had been displayed until then (in this example, the first image is the virtual image VI itself, but may also be another appropriate image corresponding to the virtual image VI), is reduced in the background image BK located within the field of view of the driver DR and the first image becomes dim and disappears (fades-out). This is followed by a state where only the background image BK is displayed, as illustrated in the middle section of the thick dashed line (in other words, a no image state where neither the virtual image VI nor the real image RI is displayed). Then, as illustrated below the thick dashed arrow in the figure, brightness of the second image corresponding to the real image RI (in this example, the second image is the real image RI itself, but may also be another appropriate image corresponding to the real image RI) is increased in contrast to the above and the second image gradually becomes clear, as a dynamic display, and emerges in the background image BK located within the field of view of the driver DR (fades-in). Finally, after achieving a state where the second image is displayed completely clearly within the background image BK, switching to a display state of the real image RI corresponding to the automatic driving mode by the switching processing unit 22 is performed.

### Switching from Automatic Driving Mode to Manual Driving Mode

FIG. 7 is an explanatory diagram illustrating behavior of the above-mentioned dynamic display when switching from the automatic driving mode to the manual driving mode is performed.

As described above, in the automatic driving mode, the seat 50 is in the relaxed position as illustrated on the left side of FIG. 7, and the switching processing unit 22 causes the real image RI to be displayed.

In the manual driving mode, the seat 50 is in the driving position as illustrated on the right side of FIG. 7, and the switching processing unit 22 causes the virtual image VI to be displayed.

When the driving mode is switched from the automatic driving mode to the manual driving mode, forward motion (in the front-rear direction) of the seat 50 (from the relaxed position to the driving position) is detected by the detection unit 21. In response to the detection, as illustrated above the thick dashed arrow in the figure, the switching notification unit 24 performs control, as a dynamic display, such that brightness of the second image corresponding to the real image RI that had been displayed until then (in this example, the second image is the real image RI itself, but may also be another appropriate image corresponding to the real image RI), is reduced in the background image BK located within the field of view of the driver DR and the second image becomes dim and disappears (fades-out). This is followed by a state where only the background image BK is displayed, as illustrated in the middle section of the thick dashed line (in other words, a no image state where neither the real image RI nor the virtual image VI is displayed). Then, as illustrated below the thick dashed arrow in the figure, brightness of the first image corresponding to the virtual image VI (in this example, the first image is the virtual image VI itself, but may also be another appropriate image corresponding to the virtual image VI) is increased in contrast to the above and the first image gradually becomes clear, as a dynamic display, and emerges in the background image BK located within the field of view of the driver DR (fades-in). Finally, after achieving a state where the first image is displayed completely clearly within the background image BK, switching to a display state of the virtual image VI corresponding to the manual driving mode by the switching processing unit 22 is performed.

### Dynamic Display of Switching Notification and Timing of Seat Movement

In this variation, as in the above embodiment, when the display switching between the virtual image VI and the real image RI is performed, the timing of execution of the dynamic display of the switching notification under the control of the switching notification unit 24 is caused to coincide with the timing of switching of the position or posture of the seat 50. Processing for this can be the same as or similar to that illustrated in FIGS. 5A and 5B (in FIGS. 5A and 5B, “dynamic in” corresponds to fade-in, and “dynamic out” corresponds to fade-out), so description thereof is omitted.

### Effects of Variation

In this variation, similar effects as those of the above embodiment are achieved. In other words, switching notification is provided by dynamic display of the first image or the second image both during display switching from the virtual image VI to the real image RI and during display switching from the real image RI to the virtual image VI, and thus the driver DR can be strongly impressed with the switching of the driving mode. Furthermore, an indication that the completion of the dynamic display is the same as the completion of the switching of the seat 50 is provided, and thus the driver DR can be surely and strongly impressed with the switching of the driving mode.

In particular, in this variation, a change in the position of the seat portion 51 in the front-rear direction is detected in the seat detection process, and fade-in and fade-out of the first image or the second image are performed in the switching notification process, and thus the present embodiment can provide a specific configuration for executing these two processes in conjunction with each other.

Instead of fade-in and fade-out of the first image or the second image, slide-in and slide-out of the first image or the second image may be performed as in the above-described embodiment.

In particular, in this variation, a rearward motion or the opposite motion to the front side of the seat portion 51 of the seat 50 is detected in the seat detection process, and fade-in and fade-out of the first image or the second image are performed in the switching notification process, and thus these two processes can be performed in conjunction with each other.

In particular, in this variation, when the display is switched from the virtual image VI to the real image RI, the seat portion 51 moves rearward, and the position of the driver DR also moves rearward. In accordance with this, the brightness of the first image corresponding to the virtual image VI is reduced and the first image becomes dim and disappears (fades-out), and the brightness of the second image corresponding to the real image RI is increased and the second image gradually becomes clear to emerge (fades-in).

Similarly, when the display is switched from the real image RI to the virtual image VI, the seat 50 moves forward and the position of the driver DR also moves forward. In accordance with this, the brightness of the second image corresponding to the real image RI is reduced and the second image becomes dim and disappears (fades-out), and the brightness of the first image corresponding to the virtual image VI is increased and the first image gradually becomes clear to emerge (fades-in).

According to this variation, as described above, switching notification is provided in a manner that matches the change in the position of the driver DR due to change in the position of the seat 50, and thus the driver DR can be more effectively impressed with the switching of driving mode.

(2) Changing of Posture of Concave Mirror in Conjunction with Dynamic Display of Switching Notification

In the above embodiment, as described above, for the manual driving mode, the seat 50 transitions to the driving position with a small tilt angle of the backrest portion 52 and switching to a state of displaying the virtual image VI is performed, and for the automatic driving mode, the seat 50 transitions to the relaxed position with a large tilt angle of the backrest portion 52 and switching to a state of displaying the real image RI is performed.

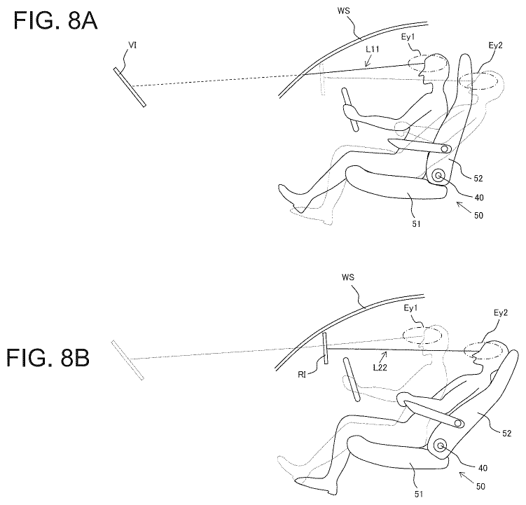

In the driving position, display processing is executed such that the driver DR visually recognizes the virtual image VI in the region of an eyebox Ey1, as illustrated by the solid line in FIG. 8A, and in the relaxed position, display processing is executed such that the driver DR visually recognizes the real image RI in the region of an eyebox Ey2, as illustrated by the solid line in FIG. 8B. The driver DR of vehicle C can visually recognize the virtual image VI and the real image RI which are displayed on the far side and the near side relative to the windshield WS, respectively, by visually recognizing, at a viewpoint in the region of an eyebox Ey (Ey1, Ey2), the display light L11, L22 reflected by the windshield WS. Here, as illustrated in FIGS. 8A and 8B, in the vehicle C, the center position of the eyebox Eyl is set to be located forward of and above the eyebox Ey2.

In this variation, a concave mirror switching process for switching the posture of the concave mirror such that dynamic display of the above-described switching notification is performed at a position in the up-down direction in accordance with a change in the eyebox Ey of the driver DR between the driving position and the relaxed position, is executed by the control unit 15 outputting a control signal to an appropriate drive mechanism (not illustrated) that rotates the concave mirror 1330 to change the posture of the concave mirror 1330.

As described above, a change in posture of the seat 50 by a reclining motion to the back side or the opposite motion to the upright state of the backrest portion 52 of the seat 50 due to a change in the tilt angle, which is detected in the seat detection process executed by the detection unit 21, results in a change in a position of the eyebox Ey of the driver DR in a height direction. In accordance with this, in this variation, the control unit 15 executes the concave mirror switching process to switch the posture of the concave mirror 1330 provided in the reflection unit 13, such that dynamic display is performed at a position in the up-down direction in accordance with the change in the eyebox Ey. Such switching notification performed in a manner that matches the positional change of the eyebox Ey allows the driver DR to surely visually recognize the switching notification even while changing the angle of the backrest portion 52 of the seat 50.

### (3) Other Variations

In the above, the slide-in and slide-out, fade-in and fade-out are performed as the dynamic display of switching notification, but instead of these, zoom-in, which gradually enlarges the display while narrowing the display range, and conversely, zoom-out, which gradually reduces the display while widening the display range, may be performed.

In addition, in the above description, the display device for vehicles 1 switches the display between the virtual image VI and the real image RI by alternately turning on/off the two PGUs (the first PGU 10b and the second PGU 10a), but the present invention is not limited thereto.

For example, one display unit may include a switching component that switches the polarization of the emitted display light between S-polarization and P-polarization. In this case, the reflection unit 13 includes a first mirror that reflects S-polarized display light and transmits P-polarized display light, a second mirror that reflects the display light passing through the first mirror, and a third mirror that reflects the display light reflected by the first mirror and the display light reflected by the second mirror and emits the reflected light onto the windshield WS.

To allow, in the manual driving mode, the driver DR to visually recognize the virtual image VI, the switching component is switched to emit the display light as S-polarized light, and a display image represented by the display light is displayed on the windshield WS by an imaging optical system formed by the first mirror, the third mirror, and the windshield WS. In addition, for example, to allow, in the automatic driving mode, the driver DR to visually recognize the real image RI, the switching component is switched to emit the display light as P-polarized light, and a display image represented by the display light is displayed on the windshield WS by an imaging optical system formed by the second mirror, the third mirror, and the windshield WS.

Note that any method other than the above methods can be used for display switching between the virtual image VI and the real image RI.

For example, display switching between the virtual image VI and the real image RI may be achieved by sliding motion of the position of one display unit in the optical axis direction to change the distance between the optical focus and the display unit. Alternatively, display switching between the virtual image VI and real image RI may be achieved by shifting the axis of the rays emitted from the display unit, to form a different optical system, when performing switching between displaying the virtual image VI and displaying the real image RI.

Furthermore, if it is desired to adjust the inclination angle of the virtual image VI and/or the real image RI relative to the road surface, a motor that enables pitching rotation of the display unit when the optical axis direction is the rolling axis may be included, for example. The tilt of the display unit may be changed by this motor to display the real image RI standing perpendicularly to the road surface, or the virtual image VI tilted relative to the road surface.

### REFERENCE SIGNS LIST

1 HUD device (display device for vehicles)
10a Second PGU
10b First PGU
11a Second light source
11b First light source
12a Second display unit
12b First display unit
13 Reflection unit
15 Control unit
16 Housing
17 Opening portion
18 Cover glass
21 Detection unit
22 Switching processing unit
23 Display control unit
24 Switching notification unit
25 External information
30 Various devices
40 Measurement sensor
50 Seat
51 Seat portion
52 Backrest portion
1310 Second correction mirror
1320 First correction mirror
1330 Concave mirror
BK Background image
C Vehicle
DR Driver
Eye Eyebox
Ey1 Eyebox
Ey2 Eyebox
F1 Second optical focus
F2 First optical focus
L11 Second display light
L22 First display light
VI Virtual image
RI Real image
WS Windshield

1. A display device for vehicles, for being installed in a vehicle including a seat for an occupant and a light transmissive member and for emitting display light from an emission port toward the light transmissive member to switchably cause a first display image or a second display image to be visible, the first display image and the second display image being display images represented by the display light, the display device for vehicles comprising:
a display unit that includes a display component, transmits light emitted by a light source, and displays the first display image or the second display image;
a reflection unit that reflects, toward the light transmissive member, first display light or second display light representing the first display image or the second display image displayed on the display unit, respectively; and
a control unit, wherein
the control unit executes,
a display switching process for performing display switching to cause the first display image to be visible when the vehicle is in a manual driving mode, and to cause the second display image to be visible when the vehicle is in an automatic driving mode,
a seat detection process for detecting switching of a position or posture of the seat in association with switching between the manual driving mode and the automatic driving mode of the vehicle, and
a switching notification process for providing switching notification by dynamic display of a first image or a second image corresponding to the first display image and the second display image, respectively, during the switching between the first display image and the second display image in the display switching process.

2. The display device for vehicles according to claim 1, wherein the control unit causes a timing of completion of the dynamic display in the switching notification process to coincide with a timing of completion of the switching of the position or posture of the seat detected in the seat detection process.

3. The display device for vehicles according to claim 2, wherein the control unit further causes a timing of start of the dynamic display in the switching notification process to coincide with a timing of start of the switching of the position or posture of the seat detected in the seat detection process.

4. The display device for vehicles according to claim 1, wherein the first display image is a virtual image, and the second display image is a real image.

5. The display device for vehicles according to claim 4, wherein
the seat includes a seat portion and a backrest portion, and
the control unit
detects, in the seat detection process, execution in the vehicle, of at least one of an angle change process for changing a tilt angle of the backrest portion, a forward-rearward change process for changing a position of the seat portion in a front-rear direction, and an upward-downward change process for changing the position of the seat portion in an up-down direction, and
performs, in the switching notification process, the dynamic display being at least one of slide-in and slide-out of the first image or the second image, fade-in and fade-out of the first image or the second image, and zoom-in and zoom-out of the first image or the second image.

6. The display device for vehicles according to claim 5, wherein the control unit
detects, in the seat detection process, execution in the vehicle, of the angle change process, and
performs, in the switching notification process, the slide-in and slide-out as the dynamic display.

7. The display device for vehicles according to claim 6, wherein
if, when display switching from the virtual image to the real image in the display switching process is performed, an increase in the tilt angle is detected in the seat detection process, the control unit executes, in the switching notification process, slide-out of the first image in an upward direction of a field of view and slide-in of the second image to the field of view from below, and
if, when display switching from the real image to the virtual image in the display switching process is performed, a decrease in the tilt angle is detected in the seat detection process, the control unit executes, in the switching notification process, slide-out of the second image in a downward direction of a field of view and slide-in of the first image to the field of view from above.

8. The display device for vehicles according to claim 5, wherein the control unit
detects, in the seat detection process, execution in the vehicle, of the forward-rearward change process, and
performs, in the switching notification process, the fade-in and the fade-out as the dynamic display.

9. The display device for vehicles according to claim 8, wherein
if, when display switching from the virtual image to the real image in the display switching process is performed, rearward movement of the seat portion is detected in the seat detection process, the control unit executes, in the switching notification process, fade-out of the first image and fade-in of the second image, and
if, when display switching from the real image to the virtual image in the display switching process is performed, forward movement of the seat portion is detected in the seat detection process, the control unit executes, in the switching notification process, fade-out of the second image and fade-in of the first image.

10. The display device for vehicles according to claim 6, wherein
the reflection unit includes a concave mirror that reflects, toward the light transmissive member, the first display light or the second display light incident on the concave mirror, and
the control unit further executes
a concave mirror switching process for switching a posture of the concave mirror such that the dynamic display is performed at a position in the up-down direction in accordance with a change of an eyebox of the occupant due to the angle change process in the vehicle.
